(19) United States
(12) Patent Application Publication
(10) Pub. No.: US 2020/0096382 A1
(43) Pub. Date: Mar. 26, 2020

(54) SENSOR ARRANGEMENT FOR INSTALLATION IN A CARRIAGEWAY AND PROCESS OF INSTALLING THIS SENSOR ARRANGEMENT IN A CARRIAGEWAY

(71) Applicant: Kistler Holding AG, Winterthur (CH)

(72) Inventor: Kim Pfluger, Winterthur (CH)

(21) Appl. No.: 16/468,790

(22) PCT Filed: Dec. 18, 2017
(86) PCT No.: PCT/EP2017/083347

§ 371 Date: Jun. 12, 2019

(30) Foreign Application Priority Data
Dec. 21, 2016 (EP) 16205904.2

(51) Int. Cl. G01G 19/02; G01L 1/16; G01G 3/13

(52) U.S. Cl. CPC G01G 19/024; G01G 3/13; G01L 1/16; G01G 19/028

(57) ABSTRACT

A sensor arrangement for installation in a carriageway includes a piezoelectric measuring arrangement disposed in a cavity of a hollow profile and in mechanical contact with the hollow profile. The hollow profile includes an external force introduction surface, which is configured to transmit a weight force onto the piezoelectric measuring arrangement, which outputs electrical signals proportional to a magnitude of the weight force. The sensor arrangement includes a separating element, which is configured to prevent a rolling force acting on the separating element from being transmitted into the hollow profile. The separating element includes at least one distribution opening configured to permit grout to flow through the distribution opening.

### TECHNICAL FIELD

The present invention relates to a sensor arrangement which is installed in a carriageway and to a process of installing this sensor arrangement in a carriageway according to the preambles of the independent claims.

### PRIOR ART

In road traffic vehicles move along a carriageway. To enhance traffic safety and to minimize damage to the carriageway surface, monitoring of the number, wheel load, axle load, total weight, tire pressure of the moving vehicles are carried out. Frequently, a sensor arrangement is installed in the carriageway for this purpose that detects a weight force of the moving vehicles. The sensor arrangement comprises a piezoelectric measuring arrangement. Whenever a vehicle crosses the sensor arrangement, the piezoelectric measuring arrangement detects a weight force caused by the traveling vehicle, the detection of the weight force occurring so quickly that it is possible for the vehicles to cross the sensor arrangement at normal traffic speed. The output of the piezoelectric measuring arrangement are electrical signals that are proportional to the magnitude of the detected weight force, which signals are forwarded to an evaluation unit where they are evaluated.

EP0654654A1, which is also published as U.S. Pat. No. 5,461,924, which is hereby incorporated herein by this reference for all purposes, demonstrates a prior art sensor arrangement to be installed in a carriageway. The sensor arrangement is introduced into a groove in the carriageway surface and cast with grout. The dimensions of the groove are such that the sensor arrangement is completely accommodated therein. The groove extends below a carriageway surface level in a longitudinal direction perpendicular or at an angle to the direction of travel of the traveling vehicles. The sensor arrangement comprises a hollow profile having a force introduction flange, a tubular part and a force anchoring flange. The force introduction flange, tubular part and force anchoring flange are made of one piece. The piezoelectric measuring arrangement is arranged in the tubular part. In the installed state, the force introduction flange is placed close to the carriageway surface level and the force anchoring flange is placed close to a bottom of the groove. The tubular part is arranged between the force introduction flange and force anchoring flange. The direction of the weight force to be detected of the traveling vehicles is vertically downwards and it acts on the hollow profile. The weight force to be detected is transmitted by the force introduction flange into the tubular part and onto the piezoelectric measuring arrangement. The force anchoring flange serves to anchor the sensor arrangement in the grout.

The sensor arrangement comprises two insulating foam parts, two insulating compounds and a carriageway grouting compound. The two insulating foam parts are attached at two outer surfaces of the tubular part. The two insulating compounds are attached at two outer surfaces of the force introducing flange. The carriageway grouting compound is material-bonded to a force introduction surface of the force introduction flange and is arranged between the insulating compounds. The carriageway grouting compound fills an upper volume located between the force introduction flange and the carriageway surface level. Upper ends of the insulating compounds extend up to an upper surface of the carriageway grouting compound. The two insulating foam parts and the two insulating compounds prevent the introduction of rolling forces into the hollow profile. The weight force of a vehicle causes a deformation of the carriageway which is also referred to as deflection. When vehicles travel on the carriageway the deflection is manifested in the form of rolling forces that propagate ahead of or behind the traveling vehicles in the direction of travel. The rolling forces are transmitted to the sensor arrangement from the surface layer of the carriageway as well as from the grout and when they reach the piezoelectric measuring arrangement they may interfere with the detection of the weight force. For an accurate detection of the weight force it is therefore necessary to effectively prevent the introduction of rolling forces into the hollow profile.

For installation in the carriageway the sensor arrangement is positioned in the groove so that the upper surface of the carriageway grouting compound is flush with the carriageway surface level. Afterwards, the groove is cast with as much grout as is necessary for the lateral spaces of the groove surrounding the sensor arrangement to be filled with grout up to the carriageway surface level.

However, the weight of the sensor arrangement is very high due to the carriageway grouting compound; this is a disadvantage because it makes transportation to the site of installation costly and complicates installation of the sensor arrangement in the carriageway. Furthermore, it is also difficult to install the sensor arrangement in a carriageway with wheel ruts that extend in the direction of travel because the carriageway grouting compound will protrude above the carriageway surface level in certain areas in these wheel ruts and it will be necessary to grind down these protruding areas of carriageway grouting compound which is time-consuming and expensive. Moreover, it is impossible to install the sensor arrangement when the depth of the wheel ruts is greater than the height of the carriageway grouting compound. In this case, it would not only be required to grind down the carriageway grouting compound but also the force introduction flange in certain areas leading to impairment of the availability of the sensor arrangement. It is even recommended to grind down the carriageway grouting compound only to a minimum height above the force introduction flange in order to protect the force introduction flange against damaging environmental conditions such as corrosion, etc. Finally, it has been shown to be disadvantageous that the carriageway grouting compound may become detached from the force introduction flange as a result of a strong force such as arises during the braking of vehicles; this may result in the sensor arrangement no longer being able to correctly detect the weight force of the vehicles traveling on the carriageway which also impairs the availability of the sensor arrangement.

### BRIEF OBJECTS AND SUMMARY OF THE INVENTION

A first object of the present invention is to simplify a construction of the sensor arrangement for installation in a carriageway known from the prior art. Another object of the present invention is to reduce the costs for transporting the sensor arrangement to the installation site and for the installation of the sensor arrangement in the carriageway. Yet another object of the present invention is to keep the availability of the sensor arrangement at a high level. A sensor arrangement which accomplishes these objects desirably shall exhibit the same accuracy in detecting the weight force of vehicles traveling on the carriageway as the sensor arrangement known from the prior art.

At least one of these objects has been achieved by the features described hereinafter.

The invention relates to a sensor arrangement for installation in a carriageway; wherein the sensor arrangement comprises a hollow profile and a piezoelectric measuring arrangement; said hollow profile comprising a cavity and said piezoelectric measuring arrangement being arranged in the cavity in mechanical contact with the hollow profile; wherein the hollow profile comprises an external force introduction surface and the hollow profile transmits a weight force acting on said force introduction surface to the piezoelectric measuring arrangement; wherein the piezoelectric measuring arrangement detects an introduced weight force and outputs electrical signals that are proportional to a magnitude of the detected weight force; wherein the sensor arrangement further comprises a separating element, which separating element prevents a rolling force acting on the separating element from being transmitted into the hollow profile; and wherein the separating element comprises at least one distribution opening wherein grout can flow through said distribution opening.

The invention also relates to a process for installing a sensor arrangement in a carriageway; wherein the sensor arrangement comprises a hollow profile and a piezoelectric measuring arrangement: said hollow profile comprising a cavity and said piezoelectric measuring arrangement being arranged in the cavity in mechanical contact with the hollow profile; wherein the hollow profile comprises an external force introduction surface and the hollow profile transmits a weight force acting on the force introduction surface to the piezoelectric measuring arrangement; wherein the piezoelectric measuring arrangement detects an introduced weight force and outputs electrical signals that are proportional to a magnitude of the detected weight force; wherein a groove is formed in a pavement of the carriageway said groove having dimensions sufficient to completely accommodate the sensor arrangement therein and to provide sufficient space around the sensor arrangement to be filled with grout; wherein the sensor arrangement is inserted in the groove; wherein grout is cast into the space provided for grout; wherein the sensor arrangement comprises a separating element, which separating element prevents a rolling force acting on the separating element from being transmitted into the hollow profile, and which separating element comprises at least one distribution opening; and wherein grout flows through the distribution opening and is spread in the space provided for grout.

First, as compared to the sensor arrangement known from the prior art, the sensor arrangement according to the invention no longer uses carriageway grouting compound. Since the separating element comprises at least one distribution opening, the grout that is cast in the groove is easily distributed around the sensor arrangement in the space provided for grout. Therefore, the carriageway grouting compound is no longer necessary and the number of components of the sensor arrangement is reduced. This makes assembly of the sensor arrangement much easier and faster and also reduces the weight of the assembled sensor arrangement so that the costs for transporting the sensor arrangement to the installation site are reduced. Finally, the absence of carriageway grouting compound allows for more flexibility in installation of the sensor arrangement in the carriageway. Upon being cast into the groove the grout may flexibly adapt to the local conditions of the carriageway surface level. Thus, in the presence of wheel ruts it will be no longer be necessary to grind down areas where the carriageway grouting compound protrudes above the carriageway surface level saving time and efforts. Moreover, since the carriageway grouting compound is no longer needed it will be possible to install the sensor arrangement even where deep wheel ruts are present in the carriageway because the height of the carriageway grouting compound is no longer a limiting factor.

The sensor arrangement installed in the carriageway by the process according to the invention includes cured grout in an upper space between the force introduction surface and the carriageway surface level, it includes cured grout in at least one lateral space between the separating element and a lateral surface of the groove, and it includes cured grout in the distribution opening; wherein cured grout is material-bonded to the force introduction surface in the upper space; and wherein the cured grout in the distribution opening integrally connects the cured grout in the upper space to the cured grout in the lateral space.

Furthermore, also in comparison to the sensor arrangement known from the prior art, the sensor arrangement can be installed in the carriageway by the process according to the invention in such a way that cured grout in the upper space is not only material-bonded to the force introduction surface but also integrally connected to cured grout in the lateral space. Thus, the cured grout in the upper space is more firmly secured and can no longer come off even under a high force so that the availability of the sensor arrangement is kept high.

### BRIEF DESCRIPTION OF THE DRAWINGS

In the following the invention will be explained by way of example with reference to the figures in which

FIG. 1 is a view of a portion of a first embodiment of a sensor arrangement for installation in a carriageway;

FIG. 2 is a view of portion of a second embodiment of a sensor arrangement for installation in a carriageway;

FIG. 3 is a view of a portion of the carriageway with a groove for accommodating the sensor arrangement according to FIG. 1 or 2;

FIG. 4 is a view of a portion of the carriageway with the groove according to FIG. 3 after filling the bottom of the groove with grout;

FIG. 5 is a view of a portion of the carriageway with the groove according to FIG. 4 after placing the first embodiment of a sensor arrangement according to FIG. 1 in the groove;

FIG. 6 is a view of a portion of the carriageway with the groove according to FIG. 4 after placing the second embodiment of a sensor arrangement according to FIG. 2 in the groove;

FIG. 7 shows a view of a portion of the carriageway with the first embodiment of a sensor arrangement according to FIG. 5 placed in the groove and the groove completely filled with grout; and

FIG. 8 is a view of a portion of the carriageway with the second embodiment of a sensor arrangement according to FIG. 6 placed in the groove and the groove completely filled with grout.

### DESCRIPTION OF EXEMPLARY EMBODIMENTS OF THE PRESENT INVENTION

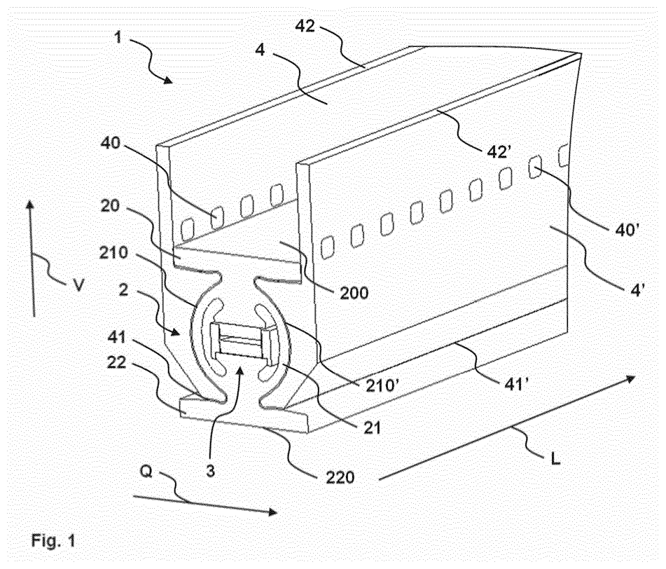

FIGS. 1, 2, and 5 to 8 show two preferred embodiments of an sensor arrangement 1 according to the invention before and after installation in a carriageway. Sensor arrangement 1 has dimensions in the longitudinal direction L, transverse direction Q and vertical direction V. The three directions are perpendicular to one another. A dimension of the sensor arrangement 1 along the longitudinal direction L is substantially greater than that along the transverse direction Q and that along the vertical direction V. Preferably, the sensor arrangement has a length of 1000 mm or more in the longitudinal direction L, while it has a width of about 30 mm to 50 mm in the transverse direction Q as well as a height of 20 mm to 70 mm in the vertical direction. The longitudinal direction L and the transverse direction Q create a longitudinal plane. The vertical direction V and the longitudinal direction L create a vertical plane. The transverse direction Q and the vertical direction V create a transverse plane.

Sensor arrangement 1 comprises a hollow profile 2, a piezoelectric measuring arrangement 3 and at least one separating element 4, 4′, 4″.

The hollow profile 2 comprises a force introduction flange 20, a tubular member 21 and a force anchoring flange 22, Hollow profile 2 is made of mechanically resistant material such as pure metals, aluminum alloys, nickel alloys, cobalt alloys, iron alloys, etc. The force introduction flange 20 and force anchoring flange 22 are T-shaped as seen along a section in the transverse plane. The tubular part 21 is circular as seen along a section in the transverse plane. The hollow profile 2 is preferably mirror-symmetrical with respect to a vertical plane placed in the center of the hollow profile 2. Preferably, the force introduction flange 20, tubular part 21 and force anchoring flange 22 are made of one piece.

Tubular part 21 is arranged between the force introduction flange 20 and the force anchoring flange 22. A center of the hollow profile 2 coincides with the center of the tubular part 21. The center refers to a geometric center.

The force introduction flange 20 and force anchoring flange 22 are designed as compact and very stiff members. A weight force to be detected of traveling vehicles acts along the vertical direction V onto the force introduction surface 200. The weight force to be detected is transmitted by the force introduction flange 20 into the tubular part 21 along the vertical direction V. Anchoring 220 serves to anchor the hollow profile 2 in a grout in a groove of the carriageway.

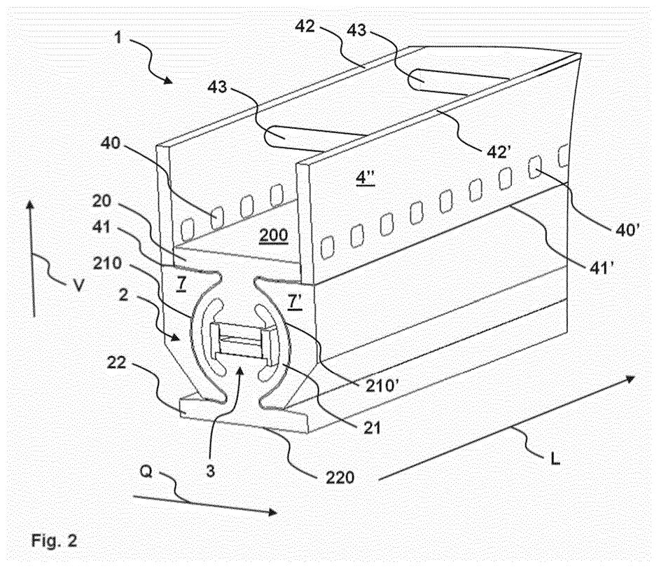

As shown in FIGS. 1 and 2 for example, the force introduction flange 20 defines a force introduction surface 200. The force introduction surface 200 is arranged outwards with respect to the center of the force introduction flange 20 and extends in a plane along the longitudinal direction L. In the installed state shown in FIG. 8 for example, the force introduction flange 20 is located closely below a carriageway surface level E. The position of the force introduction surface 200 closely below the carriageway surface level E is intended to mean a shortest distance between the force introduction surface 200 and the carriageway surface level E of less than 20 mm, preferably less than 10 mm. The force introduction flange 20 begins at the force introduction surface 200 and ends in a transition region that connects to the tubular part 21.

The force anchoring flange 22 begins in a transition region that connects to the tubular part 21 and ends at an anchoring 220. Anchoring 220 is plate-shaped and extends in the longitudinal plane. In the installed state shown in FIG. 8 for example, the force anchoring flange 22 is located closely above a bottom 600 of the groove 60. A position of the force anchoring flange 22 closely above the bottom 600 of the groove 60 is intended to mean a shortest distance between the force anchoring flange 22 and the bottom 600 of less than 20 mm, preferably less than 10 mm.

The piezoelectric measuring arrangement 3 is arranged in the center of the tubular part 21. The piezoelectric measuring arrangement 3 comprises a plurality of piezoelectric elements. The piezoelectric elements are disc-shaped and are made of piezoelectric crystal material such as quartz (SiO₂ single crystal), calcium gallo-germanate (Ca₃Ga₂Ge₄O₁₄ or CGG), langasite (La₃Ga₅SiO₁₀ or LGS), tourmaline, gallium orthophosphate, piezoceramics, etc. The crystallographic orientation of the piezoelectric elements is such that they have a high sensitivity for the weight force to be detected. Preferably, the orientation of the piezoelectric elements is such that negative and positive electrical polarization charges are generated on those surfaces on which the weight force acts along the vertical direction V. The number of the electrical polarization charges is proportional to the magnitude of the detected weight force. The electrical polarization charges are received as electrical signals by electrodes and are transmitted by electrical conductors to an evaluation unit (not shown) where they are evaluated.

Preferably, the piezoelectric measuring arrangement 3 comprises a plurality of piezoelectric elements arranged at a distance of 50 mm to 100 mm from one another along the longitudinal axis L on a ruler. The ruler carrying the piezoelectric elements is pushed into a central cavity of the tubular part 21. The dimension of the piezoelectric measuring arrangement 3 is slightly smaller in the vertical direction V than that of the cavity. The tubular part 21 has a thin-walled and elastic design. Thus, in preparing to install the piezoelectric measuring arrangement 3 into the central cavity of the tubular part 21, the tubular part 21 may be bent open in the vertical direction V by pressing to the sides in and against the transverse direction Q, and then the ruler together with the piezoelectric elements is pushed into the cavity in the longitudinal direction L. Upon termination of the lateral pressing, the piezoelectric measuring arrangement 3 is held in the cavity under a mechanical prestress. The mechanical prestressing is in and against the vertical direction V. Thus, the piezoelectrical measuring arrangement 3 is in mechanical contact to the hollow profile 2. A force shunt across the thin walls of the tubular part 21 is small. A majority of the weight force to be detected is transmitted by the force introduction flange 20 into the piezoelectric measuring arrangement 3 arranged in the central cavity of the tubular part 21.

The separating element 4, 4′, 4″ is made of material with low bulk modulus and low elastic modulus such as silicone foam, rubber, expanded polypropylene (EPP), ethylene-propylene-diene rubber (EPDM), etc. Preferably, the length of the separating element 4, 4′, 4″ in the longitudinal direction L is identical to that of the hollow profile 2.

In the first embodiment of a sensor arrangement 1 according to FIG. 1, the separating element 4, 4′ is attached to at least one attachment surface 210, 210′ of the hollow profile 2. The attachment surface 210, 210′ is situated outwards with respect to the center and extends in the vertical plane. The attachment surface 210, 210′ extends from the force introduction surface 200 to the anchoring 220. The separating element 4, 4′ extends in the vertical plane. Preferably, the separating element 4, 4′ covers the attachment surface 210, 210′. Attachment of the separating element 4, 4′ to the hollow profile 2 is achieved by a positive and/or frictional and/or material connection. Preferably, the separating element 4, 4′ is placed on the attachment surface 210, 210′.

Preferably, in the first embodiment of a sensor arrangement 1 according to FIG. 1, two separating elements 4, 4′ are attached to two attachment surfaces 210, 210′. A first separating element 4 is fastened to a first attachment surface 210. A second separating element 4′ is fastened to a second attachment surface 210′. In the installed state, the first separating element 4 is arranged in front the hollow profile 2 as seen in the direction of travel, and the second separating element 4′ is arranged behind the hollow profile 2 as seen in the direction of travel. The direction of travel corresponds to the transverse direction Q. Preferably, the two separating elements 4, 4′ are mirror-symmetrical with respect to a vertical plane placed in the center of the hollow profile 2. A distance between the two separating elements 4, 4′ in the direction of travel is constant.

In the first embodiment of a sensor arrangement 1 according to FIG. 1, the separating element 4, 4′ comprises at least one lower end 41, 41′. The lower end 41, 41′ delimits the separating element 4, 4′ in the vertical plane. In the vertical direction V, the lower end 41, 41′ is located in the transition region from the tubular part 21 to the force anchoring flange 22. In the longitudinal direction L, the lower end 41, 41′ extends substantially parallel to anchoring 220.

In the second embodiment of a sensor arrangement 1 according to FIG. 2, the separating element 4″ is fastened to the force introduction flange 20. Preferably, separating element 4″ is attached outwards with respect to the center of the force introduction flange 20. Separating element 4″ extends in the vertical plane. Preferably, separating element 4″ covers lateral surfaces of the force introduction flange 20, which lateral surfaces extend in the vertical plane. Preferably, the separating element 4″ completely covers the lateral surfaces of the force introduction flange 20. Attachment of the separating element 4″ at the force introduction flange 20 is achieved by a positive and/or frictional and/or material connection. Preferably, the separating element 4″ is placed on the force introduction flange 20.

In the second embodiment of a sensor arrangement 1 according to FIG. 2, the separating element 4″ comprises at least one lower end 41, 41′, which lower end 41, 41′ delimits the separating element 4″ in the vertical plane. The separating element 4″ is fastened to the force introduction flange 20 by a first lower end 41 in front of the hollow profile 2 as seen in the direction of travel. The separating element 4″ is fastened to the force introduction flange 20 by a second lower end 41′ behind the hollow profile 2 as seen in the direction of travel. The direction of travel corresponds to the transverse direction Q. Preferably, the two lower ends 41, 41′ of the separating element 4″ are mirror-symmetrical with respect to a vertical plane placed in the center of the hollow profile 2. A distance between the two lower ends 41, 41′ of the separating element 4″ in the direction of travel is constant.

In the second embodiment of a sensor arrangement 1 according to FIG. 2, the separating element 4″ is preferably made of one piece wherein the portion of the separating element 4″ that comprises the first lower end 41 is mechanically connected to the portion of the separating element 4″ that comprises the second lower end 41′ by at least one spacer element 43. The spacer element 43 is preferably rib-shaped. In the direction of travel Q, a plurality of spacer elements 43 are arranged to extend between the portion of the separating element 4″ comprising the first lower end 41 and the portion of the separating element 4″ comprising the second lower end 41′. Spacer element 43 serves to keep the portion of the separating element 4″ comprising the first lower end 41 and the portion of the separating element 4″ comprising the second lower end 41′ at a constant distance from each other as seen in the direction of travel.

The second embodiment of a sensor arrangement 1 according to FIG. 2 comprises at least one insulating foam part 7, 7′. Like the separating element 4, 4′, 4″, the insulating foam part 7, 7′ consists of material with low bulk modulus and low elastic modulus such as silicone foam, rubber, expanded polypropylene (EPP), ethylene-propylene diene rubber (EPDM), etc. Preferably, the insulating foam part 7, 7′ has the same length as the hollow profile 2 in the longitudinal direction L. Moreover, hollow profile 2 comprises at least one external attachment surface 210, 210′. A first insulating foam part 7 is fastened to a first attachment surface 210, a second insulating foam part 7′ is fastened to a second attachment surface 210′. In the installed state, the first insulating foam part 7 is arranged in front of the hollow profile 2 as seen in the direction of travel and the second insulating foam part 7′ is arranged behind the hollow profile 2 as seen in the direction of travel Q. The direction of travel corresponds to the transverse direction Q. Preferably, the two insulating foam parts 7, 7′ are mirror-symmetrical with respect to a vertical plane placed in the center of the hollow profile 2. A distance between the two insulating foam parts 7, 7′ in the direction of travel Q is constant. Separating element 4″ abuts on the first insulating foam part 7 with its first lower end 41, and separating element 4″ abuts on the second insulating foam part 7′ with its second lower end 41′. Preferably, the first lower end 41 of the separating element 4″ abuts flush with the first insulating foam part 7 and the second lower end 41′ of the separating element 4″ abuts flush with the second insulating foam part 7′.

Rolling forces are generated when the carriageway is deflected due to the weight of vehicles traveling on the carriageway. The rolling forces propagate in the direction of travel, they act ahead of the moving vehicles in the direction of travel and they act behind the vehicles. The magnitude of the rolling forces decreases below the carriageway surface with increasing distance from the carriageway surface. Due to the low bulk modulus and low elastic modulus of the separating element 4, 4′, 4″, the separating element 4, 4′, 4″ is deformed by the action of the rolling forces and the propagating rolling forces are not introduced into the hollow profile 2. This is also called rolling force decoupling. Thus, the separating element 4, 4′, 4″ effectively prevents the introduction of rolling forces into the hollow profile 2.

The separating element 4, 4′, 4″ defines at least one distribution opening 40, 40′ wherein grout can flow through said distribution opening 40, 40′. In the embodiments according to FIGS. 1 and 2, a plurality of circular distribution openings 40, 40′ are formed in the separating element 4, 4′, 4″. However, because the cross-sectional shape of the distribution openings 40, 40′ is not limited to a circle, with knowledge of the present invention, the distribution opening 40 may also be an elongated hole, an elongated slot, a polygon, etc.

The separating element 4, 4′, 4″ defines at least one upper end 42, 42′. Upper end 42, 42′ delimits the separating element 4, 4′, 4″ in the vertical plane. Upper end 42, 42′ is located above the force introduction surface 200 as seen in the vertical direction V. The separating element 4, 4′, 4″ is delimited by a first upper end 42 above the force introduction surface 200 in front of the hollow profile 2 as seen in the direction of travel. Separating element 4, 4′, 4″ is delimited by a second upper end 42′ above the force introduction surface 200 behind the hollow profile 2 as seen in the direction of travel. The upper end 42, 42′ extends in the longitudinal direction L substantially parallel to the force introduction surface 200. The distribution opening 40, 40′ is arranged between the lower end 41, 41′ and the upper end 42, 42′. Preferably, a plurality of distribution openings 40, 40′ are arranged in a row in the separating element 4, 4′, 4″. Preferably, the distribution opening 40, 40 is located centrally between the lower end 41, 41′ and the upper end 42, 42′. Distribution opening 40, 40 is preferably arranged close to the force introduction surface 200. A position of the distribution opening 40, 40 close to the force introduction surface 200 is intended to mean a shortest distance from an edge of the distribution opening 40, 40 to an edge of the force introduction surface 200 of less than 20 mm, preferably less than 10 mm.

FIGS. 3 to 8 show a view of a portion of a carriageway traveled by vehicles (not shown). The vehicles travel on the carriageway in or against a direction of travel F. The direction of travel F corresponds to the transverse direction Q of the sensor arrangement 1 according to FIG. 1 or FIG. 2. A surface of the carriageway is called the carriageway surface level E. The carriageway surface level E is parallel to the longitudinal plane of the sensor arrangement 1 according to FIG. 1 or 2. The carriageway comprises a pavement 6. Pavement 6 consists of mechanically resistant material such as asphalt, concrete, etc.

In a first step of the process for installing the sensor arrangement 1 in the carriageway, a groove 60 is formed in the carriageway. FIG. 3 shows the groove 60 made in the carriageway. Groove 60 is made with a suitable tool such as a milling cutter. Groove 60 extends below the carriageway surface level E. Groove 60 extends perpendicularly or at an angle to the direction of travel F. In the embodiment of a groove 60 according to FIGS. 3 to 8, the groove 60 extends along a longitudinal direction L that is perpendicular to the direction of travel F. The longitudinal direction L of the groove 60 corresponds to the longitudinal direction L of the sensor arrangement 1. The dimensions of the groove 60 are such that it can completely accommodate the sensor arrangement 1 and there is space around the sensor arrangement 1 for grout 5. Preferably, groove 60 has a rectangular cross section in the vertical plane. Groove 60 comprises a bottom 600 which extends in the longitudinal plane. Groove 60 comprises two lateral surfaces 601, 601′ each of which extends in a vertical plane. The vertical plane of the groove 60 is parallel to the vertical plane of the sensor arrangement 1.

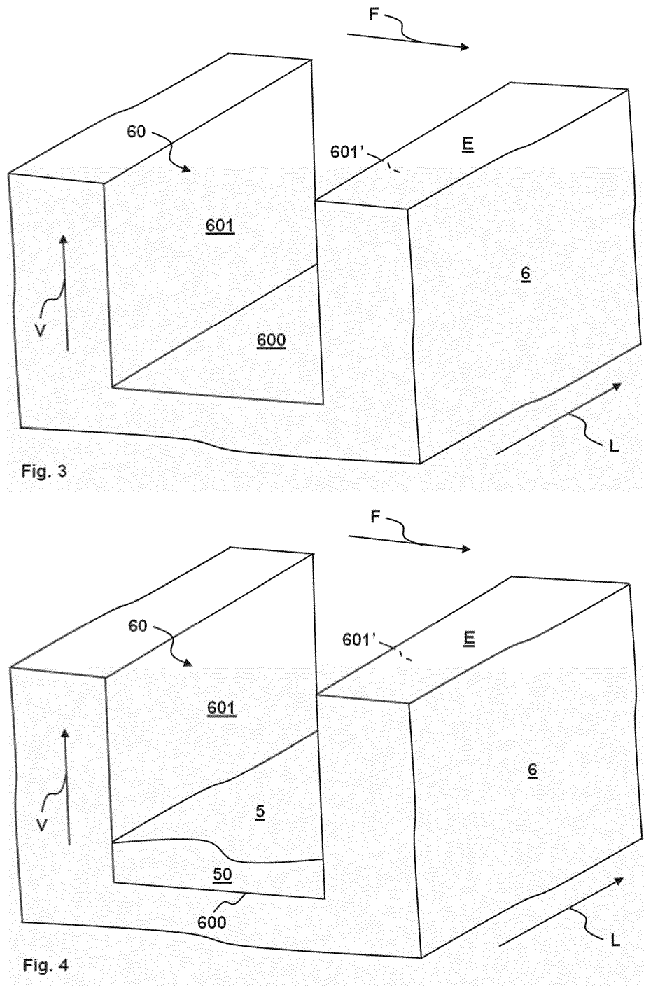

In a second process step for installing the sensor arrangement 1 in the carriageway, the empty groove 60 is partially filled with grout 5. Grout 5 consists of mechanically resistant, curable material such as polyester resin, epoxy resin, etc. Such grout 5 is sold commercially by the applicant under the type Nos. 1000A1, 1000A3. Grout 5 is filled into the groove 60 in a viscous state and cures in less than 1 h to 2 h depending on the temperature. While it cures, grout 5 undergoes a material connection with the bottom 600 and the lateral surfaces 601, 601′. FIG. 4 shows the groove 60 partially filled with grout 5. The grout 5 fills a lower space 50 of the groove 60. The lower space 50 is defined by the bottom 600 itself as well as portions of the lateral surfaces 601, 601′ near the bottom. The bottom 600 itself and portions of the lateral surfaces 601, 601′ near the bottom are completely covered with grout 5. The lower space 50 preferably constitutes 25% to 50% of the volume of the groove 60.

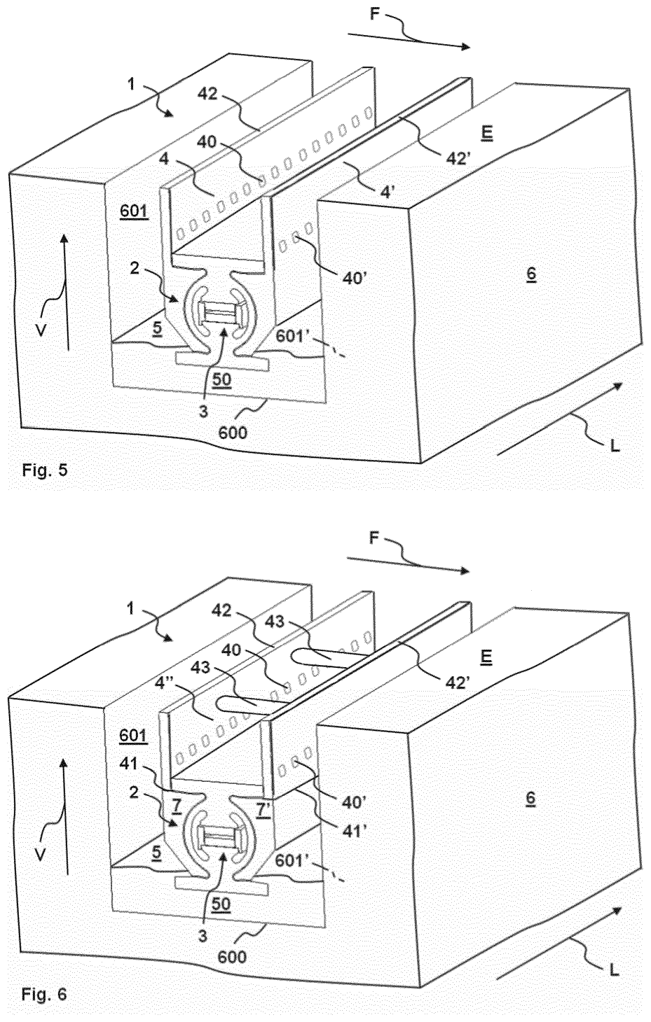

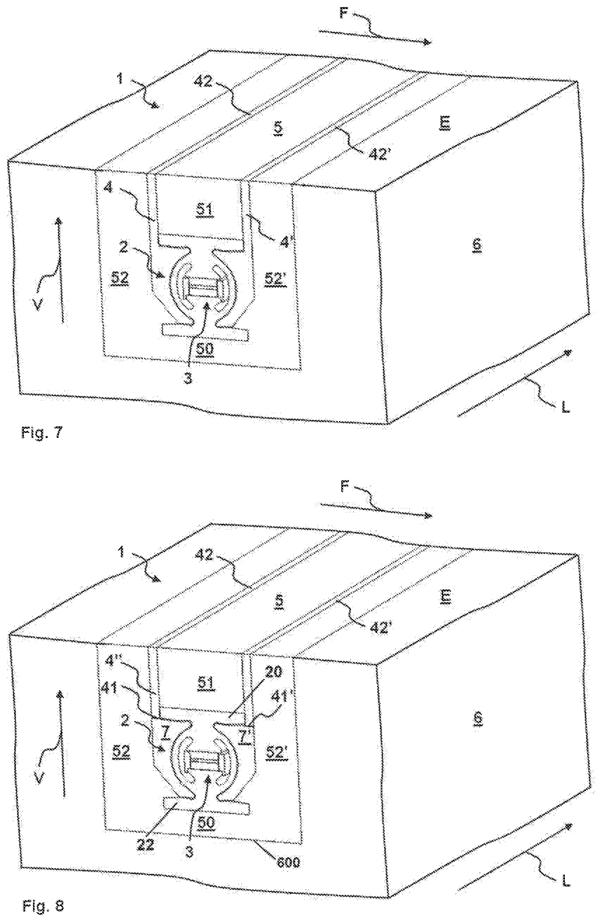

In a further process step for installing the sensor arrangement 1, the sensor arrangement 1 is introduced in the groove 60 and positioned in the groove 60. FIG. 5 shows the sensor arrangement 1 of the first embodiment according to FIG. 1 inserted in the groove 60 that is partially filled with grout 5. FIG. 6 shows the sensor arrangement 1 of the second embodiment according to FIG. 2 inserted in the groove 60 that is partially filled with grout 5. Preferably, the force anchoring flange 22 of the sensor arrangement 1 is positioned in the grout 5 so that the force anchoring flange 22 is surrounded by grout 5. The space provided for grout 5 in the groove 60 comprises lower space 50, an upper space 51 (FIGS. 7 and 8), and at least one lateral space 52, 52′(FIGS. 7 and 8). The upper space 51 s located between the force introduction surface 200 and the carriageway surface level E. The lateral space 52, 52′ is located between the separating element 4, 4′, 4″ and a lateral surface 601, 601′.

Preferably, the force anchoring flange 22 of the sensor arrangement 1 is positioned in the not yet cured grout 5 so that the force anchoring flange 22 is completely surrounded by grout 5 in the lower space 50. Preferably, anchoring 220 is completely surrounded by grout 5. Preferably, the grout 5 extends up to the transition region between the tubular part 21 and the force anchoring flange 22. Preferably, the grout 5 surrounds a lower end 41, 41′ of the separating element 4, 4′, 4″. While it cures, the grout 5 undergoes a material connection to the lower end 41, 41′ of the separating element 4, 4′, 4″. Preferably, the sensor arrangement 1 is positioned in the groove 60 in such a way that an upper end 42, 42′ of the separating element 4, 4′, 4″ is flush with the carriageway surface level E. Preferably, the sensor arrangement 1 is anchored in the groove 60 in this position by the curing of the grout 5 that surrounds the force anchoring flange 22. Once the grout 5 is finished curing, the grout 5 forms a material connection to the force anchoring flange 22.

In yet another process step for installation of the sensor arrangement 1, the groove 60 with the sensor arrangement 1 positioned therein is completely filled with grout 5. FIG. 7 shows the first embodiment of a sensor arrangement 1 according to FIG. 5 in the groove 60 that is completely filled with grout 5. FIG. 8 shows the second embodiment of a sensor arrangement 1 according to FIG. 6 in the groove 60 that is completely filled with grout 5. Upper space 51 is completely filled with grout 5 as seen in the vertical direction V. Lateral space 52, 52′ is completely filled with grout 5 as seen in and against the direction of travel F. The upper space 51 communicates with the lateral space 52, 52′ by means of the distribution opening 40, 40′ in the separating means 4, 4′, 4″. When the groove 60 is filled by means of the distribution opening 40, 40′, grout 5 spreads in the upper space 51 and in the lateral space 52, 52′. On curing, the grout 5 undergoes a material connection to the force introduction surface 200. On curing, the grout 5 forms a material connection to the separating element 4, 4′, 4″. Cured grout 5 in the distribution opening 40, 40′ integrally connects cured grout 5 in the upper space 51 to cured grout 5 in the lateral space 52, 52′.

The first embodiment of a sensor arrangement 1 according to Fig, 7 comprises two separating elements 4, 4′. A first separating element 4 is arranged in front of the hollow profile 2 as seen in the direction of travel F. A second separating element 4′ is arranged behind the hollow profile 2 as seen in the direction of travel F. As seen in and along the travel direction F, there is a first lateral space 52 between a first lateral surface 601 and the first separating element 4 and a second lateral space 52′ is located between a second lateral surface 601 and the second separating element 4′.

The second embodiment of a sensor arrangement 1 according to FIG. 8 comprises a separating element 4″ comprising two portions. One portion of the separating element 4″ that includes the first lower end 41 is arranged in front of the hollow profile 2 as seen in the direction of travel F. One portion of the separating element 4″ that includes the second lower end 41′ is arranged behind the hollow profile 2 as seen in the direction of travel F. As seen in and along the travel direction F, a first lateral space 52 is located between a first lateral surface 601 and the portion of the separating element 4″ that includes the first lower end 41, and a second lateral space 52′ is located between a second lateral surface 601′ and the portion of the separating element 4″ that includes the second lower end 41′,

Each separating element 4, 4′, 4″ comprises a plurality of distribution openings 40, 40′. The upper space 51 communicates with the two lateral spaces 52, 52′ via distribution openings 40, 40′ in the separating means 4, 4′, 4″. In this way, the grout 5 is distributed quickly and easily in the space provided for grout 5 around the sensor arrangement 1.

The separating element 4, 4′, 4″ comprises upper ends 42, 42′ which are flush with the carriageway surface level E after the sensor arrangement 1 has been placed in the groove 30. If wheel ruts are present in the carriageway surface level E, the upper ends 42, 42′ can be mechanically deformed due to their high elasticity so that they are neither positioned below nor above the carriageway surface level E but are instead positioned accurately flush with of the carriageway surface level E. Preferably, grout 5 is distributed in the upper space 51 and in the lateral space 52, 52′ in such a way that the first upper end 42 and the second upper end 42′ remain parallel to each other and flush with the carriageway surface level E. Preferably, when distributing the grout 5 in the upper space 51 and in the lateral space 52, 52′ the upper ends 42, 42′ are held in a parallel position to each other by means of a suitable tool such as a clamp. This ensures that the ends 42, 42′ extend up to the carriageway surface level E and effectively prevent the introduction of rolling forces in the hollow profile 2 especially in a region close to the carriageway surface level E where strong rolling forces act also after the grout 5 was cast.

### LIST OF REFERENCE NUMERALS

E carriageway surface level

F direction of travel

L longitudinal direction

Q transverse direction

V vertical direction

1 sensor arrangement

2 hollow profile

3 piezoelectric measuring arrangement

4, 4′, 4″ separating element

5 grout

6 pavement

7, 7′ insulating foam part

20 force introduction flange

21 tubular part

22 force anchoring flange

40, 40′ distribution opening

41, 41′ lower end of separating element

42, 42′ upper end of separating element

43 spacer element

60 groove

200 force introduction surface

210 attachment surface

220 anchoring

50 lower space

51 upper space

52, 52′ lateral space

600 bottom of groove

601, 601′ lateral surface of groove

1. A sensor arrangement for installation in a carriageway, the sensor arrangement comprising:
a hollow profile and a piezoelectric measuring arrangement; said hollow profile defining a cavity and said piezoelectric measuring arrangement being arranged in the cavity in mechanical contact with the hollow profile;
wherein the hollow profile includes a force introduction flange that defines an external force introduction surface and is configured and disposed to transmit a weight force acting on the force introduction surface onto the piezoelectric measuring arrangement; and
wherein the piezoelectric measuring arrangement is configured to detect an introduced weight force and configured to output electrical signals that are proportional to a magnitude of the detected weight force;
a first separating element that is configured to prevent a rolling force acting on the separating element from being transmitted into the hollow profile, and wherein the first separating element defines a distribution opening that is configured to permit grout to flow through said distribution opening.

2. The sensor arrangement according to claim 1, wherein the first separating element has a low bulk modulus and a low elastic modulus and is configured and disposed to prevent rolling forces propagating in a transverse direction perpendicular to the vertical plane from being transmitted to the hollow profile.

3. The sensor arrangement according to any of claim 1, wherein the first separating element defines a lower end that is configured and disposed to delimit the first separating element in the vertical plane; wherein the first separating element defines an upper end that is configured and disposed to delimit the first separating element in the vertical plane; wherein the distribution opening is arranged between said lower end and said upper end; and wherein the distribution opening is arranged within 20 mm of the force introduction surface.

4. The sensor arrangement according to claim 1, further comprising a second separating element;
wherein the hollow profile defines a first external attachment surface and a second external attachment surface; wherein the first separating element is attached to the first external attachment surface; wherein the second separating element is attached to the second attachment surface; wherein the first separating element is installed in the carriageway in front of the hollow profile as seen in the direction of travel; and wherein the second separating element is installed in the carriageway behind the hollow profile as seen in the direction of travel.

5. The sensor arrangement according to claim 4, wherein the first separating element is mounted outwardly on the first external attachment surface and the second separating element mounted outwardly on the second external attachment surface.

6. The sensor arrangement according to claim 4, wherein the first separating element defines a lower end that delimits the first separating element in the vertical plane; wherein the first separating element is arranged against the force introduction flange that defines the force introduction surface by said lower end.

7. The sensor arrangement according to claim 4 wherein the first separating element defines a first lower end that delimits the separating element in the vertical plane; wherein the first separating element is attached by the first lower end to the force introduction flange in front of the hollow profile as seen in the direction of travel; and wherein the second separating element is attached by a second lower end to the force introduction flange behind the hollow profile as seen in the direction of travel.

8. The sensor arrangement according to claim 7, wherein the first separating element is mounted outwardly on the force introduction flange.

9. The sensor arrangement according to claim 7, further comprising:
a first insulating foam part and a second insulating foam part:
wherein the hollow profile defines a first external attachment surface; wherein the first insulating foam part being attached to a first attachment surface in front of the hollow profile as seen in the direction of travel; wherein the second insulating foam part being attached to a second attachment surface behind the hollow profile as seen in the direction of travel; wherein the first separating element abuts on the first insulating foam part with its first lower end; and wherein the second separating element abuts on the second insulating foam part with its second lower end.

10. A process for installing a sensor arrangement in a carriageway; wherein the sensor arrangement comprises a hollow profile and a piezoelectric measuring arrangement; said hollow profile comprising a cavity and said piezoelectric measuring arrangement being arranged in said cavity in mechanical contact with the hollow profile; wherein the hollow profile comprises an external force introduction surface and the hollow profile transmits a weight force acting on said force introduction surface onto the piezoelectric measuring arrangement; wherein the piezoelectric measuring arrangement detects an introduced weight force and outputs electrical signals that are proportional to a magnitude of the detected weight force; the process comprising the steps of:
forming an empty groove in a pavement (6) of the carriageway having such dimensions that it can completely accommodate the sensor arrangement therein and space for grout around the sensor arrangement;
inserting the sensor arrangement in the groove; and
casting grout in the space provided for grout so that grout flows through a distribution opening in a separating element that prevents a rolling force acting on the separating element from being transmitted into the hollow profile and the grout becomes distributed in the space provided for grout.

11. The process according to claim 10, wherein the sensor arrangement is inserted in the empty groove when the empty groove has become partially filled with grout; and the sensor arrangement is positioned in the grout so that a force anchoring flange of the sensor arrangement becomes surrounded by grout.

12. The process according to claim 10, wherein the separating element comprises an upper end that delimits the separating element in a vertical plane and the sensor arrangement is positioned in the groove so that the upper end is flush with the carriageway surface level; and the sensor arrangement is anchored in this position in the groove by the curing of the grout that surrounds the force anchoring flange.

13. The process according to claim 10, wherein the space provided for grout is defined by an upper space located between the force introduction surface and the carriageway surface level and at least one lateral space located between the separating element and a lateral surface of the groove; and the groove is completely filled with grout so that the upper space is completely filled with grout and the lateral space is completely filled with grout.

14. The process according to claim 13, wherein the grout when it is introduced into the groove is distributed by means of the distribution opening in the upper space and in the lateral space.

15. A sensor arrangement installed in a carriageway by using the process according to claim 13, the sensor arrangement comprising:
a hollow profile defining a cavity and an external force introduction surface;
a piezoelectric measuring arrangement arranged in the cavity in mechanical contact with the hollow profile;
wherein the hollow profile is configured and to transmit a weight force acting on the force introduction surface onto the piezoelectric measuring arrangement;
wherein the piezoelectric measuring arrangement is configured to detect an introduced weight force and configured to output electrical signals that are proportional to a magnitude of the detected weight force;
a first separating element that is configured to prevent a rolling force acting on the separating element from being transmitted into the hollow profile, wherein the first separating element defines a distribution opening that is configured to permit grout to flow through said distribution opening; and
wherein the cured grout is material-bonded to the force introduction surface in the upper space; and cured grout in the distribution opening integrally connects cured grout in the upper space to cured grout in the lateral space.
